(19) United States
(12) Patent Application Publication
(10) Pub. No.: US 2025/0384368 A1
(43) Pub. Date: Dec. 18, 2025

(54) CHARGING SCHEDULING SYSTEMS BASED ON USAGE FEATURES OF ELECTRIC VEHICLES

(71) Applicant: XCHARGE ENERGY USA INC., Kyle, TX (US)

(72) Inventors: Junshuai WANG, Kyle, TX (US); Rui DING, Kyle, TX (US)

(73) Assignee: XCHARGE ENERGY USA INC., Kyle, TX (US)

(21) Appl. No.: 18/744,742

(22) Filed: Jun. 17, 2024

(51) Int. Cl. G06Q 10/0631; B60L 53/302; B60L 53/67

(52) U.S. Cl. CPC G06Q 10/06314; B60L 53/67; B60L 53/302

(57) ABSTRACT

The present disclosure provides a charging scheduling method based on a usage feature of an electric vehicle, comprising obtaining a charging feature of a vehicle to be charged based on historical usage features; generating a scheduling instruction based on an ambient temperature and the charging feature, and sending the scheduling instruction to a charging module; the scheduling instruction being configured to adjust a series-parallel state of a pulse transformer in the charging module, to adjust charging power of the charging module; and generating a heat dissipation instruction and sending the heat dissipation instruction to a ventilation module in response to the ambient temperature satisfying a preset temperature condition.

### TECHNICAL FIELD

The present disclosure relates to a field of charging management, and in particular, a charging scheduling system based on a usage feature of an electric vehicle.

### BACKGROUND

With the increase of electric vehicles, the demand for charging stations is gradually increasing. However, due to the limitations of a count of the charging stations, positions of charging sites, and the power supply capacity, this has led to charging congestion and long waiting times for users during peak charging periods. Optimizing the distribution of power to each charging station based on an actual charging capacity of the charging station and the charging demand of a vehicle to be charged is able to solve the above problems to a certain extent, but it is still not able to accurately predict and schedule different vehicles' charging demand.

There is therefore an urgent need for an intelligent charging scheduling system that may reasonably schedule electric vehicles for charging based on usage features of vehicles to be charged.

### SUMMARY

One or more embodiments of the present disclosure provide a charging scheduling system based on a usage feature of an electric vehicle, wherein the system is applied to a closed charging place, comprises: a transmission module, a charging module, a monitoring module, a ventilation module, and a processor; the transmission module is communicatively connected to one or more vehicles to be charged and configured to obtain historical usage features from an internal storage unit of the one or more vehicles to be charged, the one or more vehicles to be charged binding to a charging station; the charging module is configured to supply power to the one or more vehicles to be charged, the charging module at least including a winding, a current conversion unit and a pulse transformer; the monitoring module is configured to obtain an ambient temperature of the closed charging place, the ambient temperature including a temperature of at least one point in the closed charging place; the ventilation module is configured to implement a ventilation function to dissipate heat from the closed charging place; and the processor is communicatively connected to the transmission module, the charging module, the monitoring module, and the ventilation module respectively and the processor is configured to:

obtain a charging feature of each of the one or more vehicles to be charged based on the historical usage features; generate a scheduling instruction based on the ambient temperature, and the charging feature, and send the scheduling instruction to the charging module; the scheduling instruction is configured to adjust a series-parallel state of the pulse transformer in the charging module, to adjust a charging power of the charging module, and generate a heat dissipation instruction and send the heat dissipation instruction to the ventilation module in response to the ambient temperature satisfying a preset temperature condition.

### BRIEF DESCRIPTION OF THE DRAWINGS

This description will be further explained in the form of exemplary embodiments, which will be described in detail by means of accompanying drawings. These embodiments are not restrictive, in which the same numbering indicates the same structure, wherein:

FIG. 1 is a module diagram illustrating a charging scheduling system based on a usage feature of an electric vehicle according to some embodiments of the present disclosure;

FIG. 2 is an flowchart illustrating an exemplary charging scheduling process based on a usage feature of an electric vehicle according to some embodiments of the present disclosure;

FIG. 3 is a schematic diagram illustrating a process of determining a charging feature according to some embodiments of the present disclosure;

FIG. 4 is a schematic diagram illustrating a process of determining a stopping instruction according to some embodiments of the present disclosure; and

FIG. 5 is a schematic diagram illustrating a process of performing a guidance operation according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for those skill in the art to apply the present disclosure to other similar scenarios in accordance with these drawings without creative labor. The present disclosure can be applied to other similar scenarios based on these drawings without creative labor. Unless obviously obtained from the context or the context illustrates otherwise, the same numeral in the drawings refers to the same structure or operation.

It will be understood that the terms “system,” “device,” “unit,” and/or “module” used herein are one method to distinguish different components, elements, parts, sections, or assemblies of different levels. However, the terms may be displaced by another expression if they achieve the same purpose.

As shown in the present disclosure and the claims, unless the context clearly suggests an exception, the words “one,” “a”, “an”, and/or “the” do not refer specifically to the singular, but may also include the plural. Generally, the terms “including” and “comprising” suggest only the inclusion of clearly identified steps and elements. In general, the terms “including” and “comprising” only suggest the inclusion of explicitly identified steps and elements that do not constitute an exclusive list, and the method or device may also include other steps or elements.

Flowcharts are used in the present disclosure to illustrate operations performed by a system in accordance with embodiments of this disclosure. It should be appreciated that the preceding or following operations are not necessarily performed in an exact sequence. Instead, steps can be processed in reverse order or simultaneously. Also, it is possible to add other operations to these processes or remove a step or steps from them.

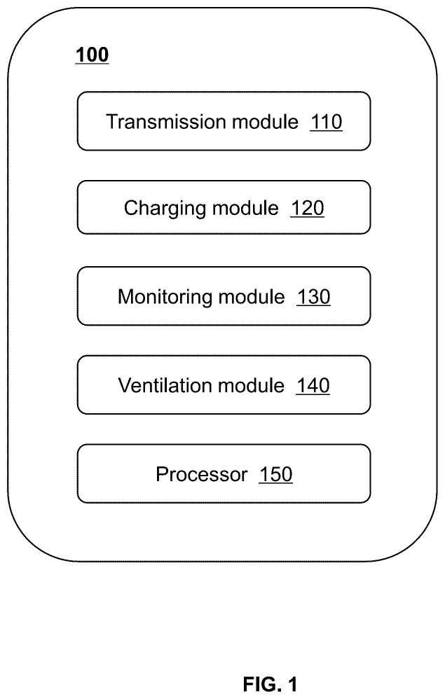

As shown in FIG. 1, a charging scheduling system 100 based on a usage feature of an electric vehicle includes a transmission module 110, a charging module 120, a monitoring module 130, a ventilation module 140, and a processor 150. In some embodiments, the charging scheduling system 100 based on the usage feature of the electric vehicle may be applied to a closed charging place.

The closed charging place is an indoor space in which a charging station exists and is capable of charging a powered vehicle. For example, an underground parking lot configured with charging stations, an indoor charging station, or the like.

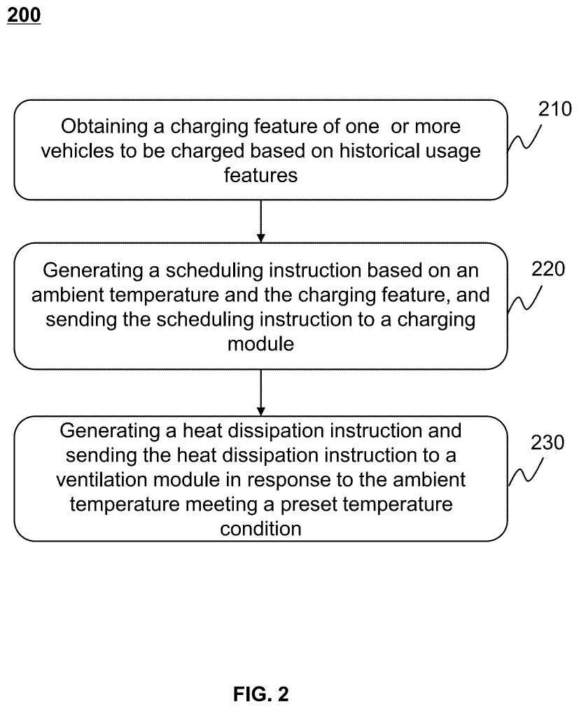

The transmission module 110 is communicatively connected to one or more vehicles to be charged and configured to obtain historical usage features from an internal storage unit of the one or more vehicles to be charged, the one or more vehicles to be charged binding to the charging station. More descriptions of the historical usage features may be found in in FIG. 2 and its related description.

The charging module 120 is configured to supply power to the one or more vehicles to be charged, the charging module typically includes multiple components.

In some embodiments, the charging module 120 includes a winding, a current conversion unit, a pulse transformer, or the like.

In some embodiments, the charging module 120 is present within the charging station, which may also include a power interface, a power connection cable, or the like.

The winding refers to a coil in electrical equipment such as a transformer, configured to generate a magnetic field or transmit electrical energy. In some embodiments, the winding may be configured to regulate an output voltage of the transformer, thereby affecting the charging power.

The current conversion unit is a unit configured to convert alternating current (AC) to direct current (DC). In some embodiments, the current conversion unit converts the AC power from the power grid into the DC power required by the electric vehicle battery. By adjusting an operating mode and an output voltage of the conversion unit, control and adjustment of the charging power may be achieved.

The pulse transformer is a device that controls output power through the use of multiple parallel or series-connected transformer windings and a rectifier corresponding to the aforementioned transformer windings, in order to regulate the input voltage and current.

In some embodiments, the charging module 120 also includes a current sensor.

In some embodiments, the current sensor is also provided in the charging module 120.

The current sensor is configured to detect the presence of a current in the charging module 120. For example, if the current sensor detects the presence of current in the charging module, the charging station corresponding to that charging module is in use, i.e., is in a powered state.

The monitoring module 130 is configured to obtain an ambient temperature of the closed charging place, the ambient temperature includes a temperature of at least one point in the closed charging place. More description of the ambient temperature may be found in FIG. 2 and its related description.

In some embodiments, the monitoring module 130 may include at least one temperature sensor.

In some embodiments, the monitoring module 130 may be a plurality of, respectively, disposed at a plurality of points of the closed charging place, and when the monitoring module detects the presence of ambient temperature data of at least one of the points that is higher than a preset temperature threshold, the processor may control the ventilation device to be open to dissipate heat.

The ventilation module 140 is configured to implement a ventilation function for dissipating heat from the closed charging place. For example, the ventilation module 140 may include a ventilation unit, such as a central ventilation unit, deployed at least one point in the closed charging place.

The processor 150 is communicatively connected to the transmission module 110, the charging module 120, the monitoring module 130, and the ventilation module 140.

In some embodiments, the processor 150 is configured to obtain the charging feature of each of the one or more vehicles to be charged based on the historical usage features; to generate a scheduling instruction based on the ambient temperature, and the charging feature, and send the scheduling instruction to the charging module; the scheduling instruction is configured to adjust a series-parallel state of the pulse transformer in the charging module, to adjust the charging power of the charging module; and to generate a heat dissipation instruction and send the heat dissipation instruction to the ventilation module in response to the ambient temperature satisfying a preset temperature condition.

In some embodiments, the processor 150 is further configured to determine a feature sampling parameter of each of the one or more vehicles to be charged, based on sub-historical usage features; determine a target sub-usage feature set of each of the one or more vehicles to be charged based on the sub-historical usage features and the feature sampling parameter; and obtain the charging feature of each of the one or more vehicles to be charged by a feature determination model based on the target sub-usage feature set, the feature determination model being a machine learning model.

In some embodiments, the processor 150 is further configured to obtain a training dataset based on historical charging data, the training dataset includes at least one sample usage feature, the sample usage feature includes a sample ambient temperature percentage, a sample charging mode percentage; divide the training dataset into at least one sub-dataset; determine a sampling ratio corresponding to each sub-dataset, sample each sub-dataset based on the sampling ratio to obtain a first training sample; and based on the first training sample, train an initial feature determination model, and obtain the feature determination model.

In some embodiments, the processor 150 is further configured to determine a charging load extreme value of the closed charging place based on the rated power of the ventilation device in the ventilation module; in response to a sum of the charging power of at least one vehicle to be charged being greater than the charging load extreme value, perform at least one of the following operations, including: generating a stopping instruction to stop adding of a new vehicle to be charged; charging the vehicle to be charged in a prioritized order.

In some embodiments, the processor 150 is further configured to determine the prioritized order based on at least one of a charging cycle variation, a battery capacity variation, and the admission time of the vehicle to be charged.

In some embodiments, the processor 150 is further configured to generate a candidate charging map; predict an estimated average temperature corresponding to the candidate charging map in a preset future time, by the temperature prediction model, the temperature prediction model being a machine learning model; and in response to the estimated average temperature corresponding to the candidate charging map satisfying a preset condition, determine the charging load extreme value based on the candidate charging map.

In some embodiments, the processor 150 is further configured to perform a guidance operation, comprising: determining a density of charging stations in operation in at least one sub-region of the closed charging place, based on the use state of the charging module; in response to the density of the charging stations in operation in the sub-region not satisfying a first density condition, performing at least one of following operations, including: generating a guidance instruction to guide each of the one or more vehicles to be charged to a specified charging position; and guiding electric vehicles in a queue to a target sub-region, the target sub-region being a region where the density satisfies a second density condition; the first density condition includes the density being less than a first density threshold; the second density condition includes the density being less than a second density threshold.

More description of the processor and the functions it performs may be found in FIG. 2-FIG .5 and their related descriptions.

Some embodiments of the present disclosure provide a charging scheduling system based on the usage feature of the electric vehicle, which is capable of adjusting the charging power based on the ambient temperature and the charging feature of each of the one or more vehicles to be charged in the closed charging place, and may realize ventilation and heat dissipation functions based on the ambient temperature to enhance the safety of the closed charging place.

It should be noted that the above description of the charging scheduling system based on the usage feature of the electric vehicle and its modules is for descriptive convenience only and does not limit the present disclosure to the scope of the cited embodiments. It should be understood that for those skilled in the art, after understanding the principle of the system, it may be possible to arbitrarily combine individual modules or form a subsystem to connect with other modules without departing from this principle. In some embodiments, the transmission module, the charging module, the monitoring module, the ventilation module, and the processor disclosed in FIG. 1 may be different modules in a single system, or a single module realizing two or two or more of the above modules. For example, the individual modules may share a common storage module, and the individual modules may each have a respective storage module. Morphs such as these are within the scope of protection of the present disclosure.

FIG. 2 is a flowchart illustrating an exemplary charging scheduling process based on a usage feature of an electric vehicle according to some embodiments of the present disclosure. As shown in FIG. 2, process 200 includes the following steps. In some embodiments, process 200 may be executed by the processor 150.

In 210, based on the historical usage features, the charging feature of each of the one or more vehicles vehicle to be charged may be obtained.

The each of the one or more vehicles vehicle to be charged is a vehicle that has been driven into or parked near a charging facility (e.g., a charging station, a charging station) but has not yet begun or is waiting to be charged. The foregoing electric vehicles may include electric vehicles (EVs) or plug-in hybrid electric vehicles (PHEVs).

The historical usage features refer to data reflecting electric vehicle travel and charging related to vehicle travel and charging over a historical time period. In some embodiments, the historical usage features may include at least one of historical cumulative mileage, historical count of charging times, and historical average length of time per charge. In some embodiments, the historical usage features may also include a variety of other feature information, such as a historical full-charge range, etc., which may be determined according to an actual situation.

The charging feature is feature related to the charging process of an electric vehicle and are data configured to describe charging behavior and status related data. In some embodiments, the charging feature may include at least one of a charging cycle variation, a battery capacity variation. In some embodiments, the charging feature may also include a variety of other feature information, such as historical charging power, which may be determined according to the actual situation.

The charging cycle variation, which refers to the change in the frequency or regularity with which an electric vehicle is charged over a period of time. For example, the charging cycle changes from once every 1 day to once every 3 days. Another example is transitioning from charging on weekdays to charging on weekends.

The battery capacity variation refers to the change in energy storage capacity of the electric vehicle battery over time, reflecting the health and aging of the electric vehicle battery. In some embodiments, the battery capacity variation may be expressed as a change in the remaining capacity of the battery relative to the initial capacity.

In some embodiments, the processor may obtain the charging feature in multiple ways.

In some embodiments, the processor may construct a feature vector based on the historical usage features and retrieve the feature vector in a vector database based on the feature vector. The vector database is constructed based on the historical data; the vector database includes a large count of reference vectors and their corresponding reference charging features, and the reference vectors are constructed based on reference usage features in the historical data. The processor may obtain a plurality of reference vectors whose vector distances from the feature vectors are less than a distance threshold, and determine the current charging features based on their corresponding reference charging features. For example, the reference charging feature corresponding to the reference vector with the smallest vector distance is determined as the current charging feature. As another example, an average of reference charging feature corresponding to reference vectors whose vector distances are less than the distance threshold is determined as the current charging feature. The distance threshold may be set based on historical experience or determined based on system defaults.

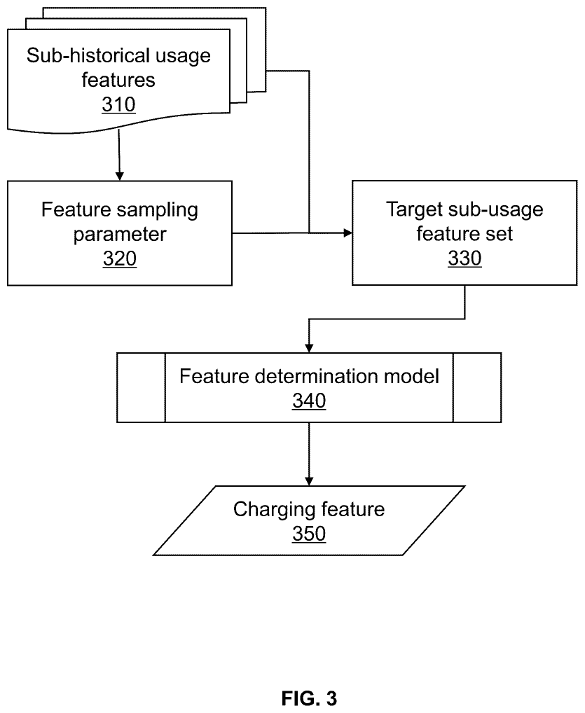

In some embodiments, the processor may determine the target sub-usage feature set of each of the one or more vehicles to be charged; obtain the charging feature of the vehicle to be charged by the feature determination model based on the target sub-usage feature set, more description in detail may be found in FIG. 3 and its related description.

In 220, a scheduling instruction based on the ambient temperature and the charging feature may be generated, and the scheduling instruction may be sent to the charging module.

The ambient temperature is the localized temperature in the closed charging place, for example, the ambient temperature may include temperatures at multiple points in the closed charging place.

In some embodiments, the ambient temperature may be obtained via the monitoring module.

The scheduling instruction is an instruction for performing charging scheduling. For example, the scheduling instruction may include an instruction for implementing operations such as controlling an operation of the charging station, adjusting the charging power, managing the charging queue, or the like, to achieve optimized scheduling and resource allocation for the system.

In some embodiments, the scheduling instruction is configured to regulate the series-parallel state of the pulse transformer of the charging module punch to regulate the charging power of the charging module.

In some embodiments, the processor may determine the charging power based on the charging cycle, the battery capacity, and by querying a first preset relationship table. The first preset relationship table may be obtained based on historical experience. The first preset relationship table includes the respective charging power corresponding to electric vehicles with different battery capacities at different ambient temperatures and different charging cycles.

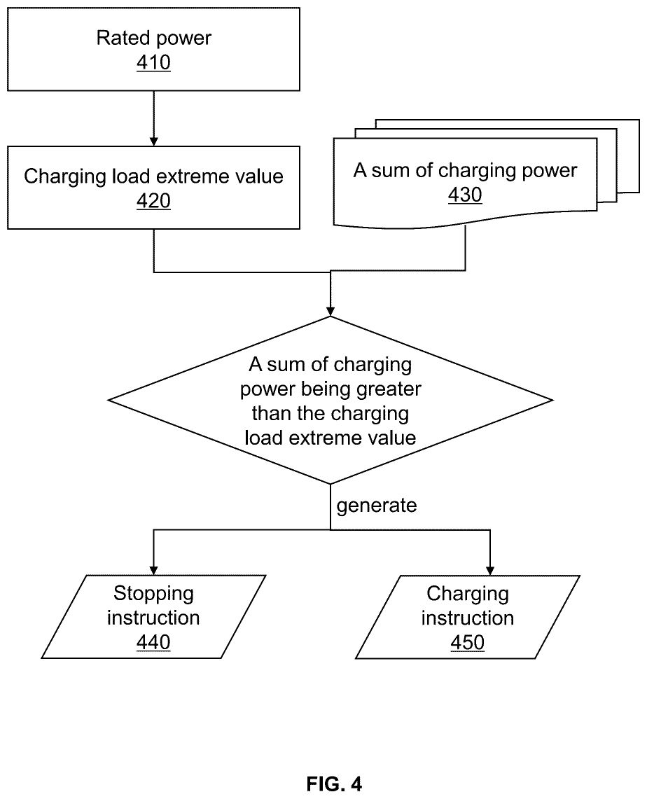

In some embodiments, the scheduling instruction may also include a stopping instruction, a guidance instruction. The stopping instruction is configured to control a pause in adding a new charging vehicle. The guidance instruction is configured to assign each of the one or more vehicles to be charged to a specified charging position. More description may be found in FIG. 3-FIG. 4 of the present disclosure and their related descriptions.

In 230, a heat dissipation instruction may be generated and sent to the ventilation module in response to the ambient temperature satisfying a preset temperature condition.

The preset temperature condition is a temperature preset for determining whether a ventilation cooling device should be turned on. In some embodiments, the preset temperature condition may include an ambient temperature above a temperature threshold. The temperature threshold may be determined based on historical data.

The heat dissipation instruction is configured to regulate an operating state of the ventilation unit in the ventilation module.

In some embodiments, the heat dissipation instruction may be determined based on the ambient temperature, and the heat dissipation instruction is generated when the ambient temperature satisfies the preset temperature condition. In some embodiments, the processor may obtain the ambient temperature of a plurality of point positions via the monitoring module, and in response to the presence of a point position where the ambient temperature is higher than the temperature threshold, generate the heat dissipation instruction to control the ventilation device corresponding to the point position to start working to lower the ambient temperature.

In some embodiments, the temperature threshold may be determined based on historical experience.

Some embodiments of the present disclosure provide a charging scheduling method based on the usage feature of the electric vehicle, which may dynamically and reasonably match the charging power with the battery capacity to protect the battery. It may also control the ventilation device inside the closed charging place, increasing air circulation to accelerate heat dissipation, thereby reducing the internal temperature of the closed charging place and ensuring the safety and stability of the charging process.

It should be noted that the foregoing process descriptions relating to the charging scheduling method based on the usage feature of the electric vehicle are for exemplary and illustrative purposes only, and do not limit the scope of application of the present disclosure. For those skilled in the art, various corrections and changes to the flow of the charging scheduling method based on the usage feature of the electric vehicle may be made under the guidance of the present disclosure. However, these corrections and changes remain within the scope of the present disclosure. For example, scheduling each of the one or more vehicles vehicle to be charged to go to a specified charging position or the like, based on the density of charging stations in operation at the closed charging place.

FIG. 3 is a schematic diagram illustrating a process of determining a charging feature according to some embodiments of the present disclosure.

In some embodiments, the historical usage features further include sub-historical usage features 310 of each of the one or more vehicles vehicle to be charged that is captured at a preset historical time.

The sub-historical usage features are historical usage features captured at the preset historical time. The sub-historical usage features include historical cumulative mileage, historical count of charge times, historical average charging hours per charge, etc., collected at a specific historical time point. The preset historical time may include a plurality of historical time points, and thus the historical usage features of each vehicle to be charged may include a plurality of sub-historical usage features. More description about the historical usage features may be found in FIG. 2 and its related descriptions.

In some embodiments, the sub-historical usage features further include a historical ambient temperature percentage, a historical charging mode percentage, captured at the preset historical time.

The historical ambient temperature percentage refers to a percentage of the ambient temperature at each charging time during historical periods. For example, the historical ambient temperature percentage may be the straight percentage of different ambient temperatures at each charging time in history.

For example, when collecting the historical usage features at a historical time point t1, each of the one or more vehicles to be charged has a historical charging frequency of 50 times, among which the ambient temperature during 20 charges was between 25° C.-26° C., during 25 charges was between 27° C.-28° C., and during 5 charges was between 30° C.-31° C., then the proportion of historical ambient temperature corresponding to the vehicle to be charged at the historical time point t1 may be expressed as (([25, 26), 40%), ([27, 28), 50%), ([30, 31), 10%)). More description about the ambient temperature may be found in FIG. 2 and its related description.

The historical charging mode percentage refers to a percentage of charging modes at each charging time during historical periods. Specifically, the historical charging mode percentage may be the straight percentage of different charging modes at each charging time in history, and the historical charging mode percentage is expressed similarly to the historical ambient temperature percentage. The charging modes may include a fast charging, a slow charging, or the like.

The ambient temperature and the charging mode during charging may affect the charging feature of each of the one or more vehicles to be charged. For example, higher ambient temperatures result in more heat generation during charging, which reduces charging efficiency and speed. Another example is the fast charging mode, which provides faster charging but may cause the battery to overheat and shorten its lifespan. Therefore, using the historical ambient temperature percentage and the historical charging mode percentage as input to the model helps determine the charging feature of the vehicle to be charged, resulting in more accurate model outputs.

In some embodiments, the processor may determine a feature sampling parameter 320 of each of the one or more vehicles to be charged based on the sub-historical usage features 310, and, based on the sub-historical usage features 310 and the feature sampling parameter 320, determine a target sub-usage feature set 330 of the vehicle to be charged.

In some embodiments, the processor may obtain the charging feature of the vehicle to be charged based on the sub-historical usage features using a feature determination model. When the count of the sub-historical usage features is too large, in order to improve the computational efficiency of the model, it is necessary to sample the sub-historical usage features to obtain the target sub-usage feature set of the vehicle to be charged as input to the feature determination model. More description of the feature determination model may be found below.

The feature sampling parameter refers to a parameter associated with sampling the sub-historical usage features. In some embodiments, the feature sampling parameter may be expressed as a fraction not greater than 1. For example, the feature sampling parameter may be ⅓, indicating that the processor selects ⅓ of the plurality of the sub-historical usage features to form the target sub-usage feature set of the vehicle to be charged.

The processor may determine the feature sampling parameter based on the sub-historical usage features in various ways. In certain embodiments, the feature sampling parameter is negatively correlated with the count of the sub-historical usage features, and the processor may determine the feature sampling parameter by querying a second preset table. The second preset table includes a correspondence between the feature sampling parameter and the sub-historical usage features, which may be obtained based on experimental data.

In some embodiments, the processor may determine the feature sampling parameter based on the count of the sub-historical usage features, the dispersion of the sub-historical usage features, and the following steps.

In 1, the count of the sub-historical usage features contained in the historical usage features of the vehicle to be charged may be determined and denoted as s, i.e., the count of historical cumulative mileage, the count of historical recharging times, and the count of historical average length of time per recharging, also denoted as s;

In 2, the dispersion of the sub-historical usage features of the vehicle to be charged may be determined.

The dispersion of the sub-historical usage features is configured to indicate the degree of dispersion of the sub-historical usage features. The greater the dispersion is, the greater the fluctuation of the sub-historical usage features is.

In some embodiments, the dispersion of the sub-historical usage features includes a first dispersion σ₁, a second dispersion σ₂, and a third dispersion σ₃. The first dispersion σ₁, the second dispersion σ₂, and the third dispersion σ₃ denote the degree of dispersion of the historical cumulative mileage, the historical count of charge times, and the historical average length of time per charge in the sub-historical usage features, respectively.

In some embodiments, the processor may take a plurality of historical cumulative mileage counts, arrange them in chronological order of acquisition to obtain a₁, a₂, . . . , aₛ, and based on the count of change in the neighboring historical cumulative mileage counts, determine the first dispersion σ₁ of the sub-historical usage features of the vehicle to be charged. For example, the first dispersion σ₁ of the sub-historical usage features of the vehicles to be charged may be calculated by the following equation (1):

$${σ}_{1} = {\sum }_{i = 2}^{i = s} \vert {a}_{i - 1} - {a}_{i} \vert \qquad ( 1 )$$

Similarly, the processor may take a plurality of historical charging counts and arrange them in the order of the time of acquisition to obtain b₁, b₂, . . . , bₛ, and determine the second dispersion σ₂ of the sub-historical usage features of the vehicles to be charged based on the count of change in the adjacent historical charging counts. For example, the second dispersion σ₂ of the sub-historical usage features of the vehicles to be charged may be calculated by the following equation (2):

$${σ}_{2} = {\sum }_{i = 2}^{i = s} \vert {b}_{i - 1} - {b}_{i} \vert \qquad ( 2 )$$

The processor may take a plurality of historical average per-charge lengths and arrange them in order of acquisition time to obtain c₁, c₂, . . . , cₛ, and based on the count of change in the neighboring historical average per-charge lengths, determine the third dispersion σ₃ of the sub-historical usage features of the vehicles to be charged. Then the third dispersion σ₃ of the sub-historical usage features of the vehicles to be charged may be calculated by the following equation (3):

$${σ}_{3} = {\sum }_{i = 2}^{i = s} \vert {c}_{i - 1} - {c}_{i} \vert \qquad ( 3 )$$

In 3, based on s, σ₁, σ₂, and σ₃, the feature sampling parameters of the vehicles to be charged may be determined.

In some embodiments, the processor may calculate the feature sampling parameter of each of the one or more vehicles to be charged using the following equation (4):

$$p = {k}_{4} ( {k}_{1} {σ}_{1} + {k}_{2} {σ}_{2} + {k}_{3} {σ}_{3} ) \qquad ( 4 )$$

where p is the feature sampling parameter; k₁, k₂, and k₃ are preset weights, and the sum of k₁, k₂, and k₃ is 1. k₁, k₂, and k₃ may be preset based on historical experience; and k₄ is a preset parameter configured to normalize p to a range of (0, 1].

The target sub-usage feature set is a set of sub-usage features selected based on the feature sampling parameter. The processor may obtain the target sub-usage feature set through multiple sampling methods. For example, the sampling methods may include a simple random sampling (a simple sampling), a systematic sampling, or the like.

In some embodiments, the processor may obtain the charging feature 350 of each of the one or more vehicles to be charged based on the target sub-usage feature set 330, through the feature determination model 340. More description about the charging feature may be found in FIG. 2 and its related description.

The feature determination model is configured to determine the charging feature of the vehicle to be charged. The feature determination model may be a deep neural networks (DNN) model, or the like.

In some embodiments, an input to the feature determination model may be the target sub-usage feature set of the vehicle to be charged, and an output may be the charging feature of the vehicle to be charged.

In some embodiments, the feature determination model may be obtained by training a plurality of first training samples with first labels. For example, the plurality of first training samples with the first labels may be input into an initial feature determination model, a loss function is constructed from the first labels and an output of the initial feature determination model, and updated based on the loss function via gradient descent or other method to iteratively update parameters of the initial feature determination model. The model training is completed when a preset condition is satisfied, and the trained feature determination model is obtained. The preset condition may be that the loss function converges, a count of iterations reaches a threshold, etc.

In some embodiments, the first training samples include a sample sub-usage feature set of historical vehicles to be charged, and the first labels are historical charging features corresponding to the historical vehicles to be charged. Both the first training samples and the first labels may be obtained based on historical data.

In some embodiments, the processor may also obtain a training dataset based on the historical charging data; divide the training dataset into at least one sub-dataset; determine a sampling ratio corresponding to each sub-dataset, and based on the sampling ratio, conduct each sub-dataset a sampling to obtain a first training sample; based on the first training sample, train the initial feature determination model, and obtain the feature determination model.

The training dataset is a collection of data configured to train the initial feature determination model. The training dataset may be obtained based on historical charging data. In some embodiments, the training dataset includes at least one sample usage feature.

The sample usage features refer to features related to the historical charging process. The sample usage features include a sample ambient temperature percentage feature, a sample charging mode percentage feature, or the like. More description about the ambient temperature and the charging mode may be found in FIG. 2 and their related description.

In some embodiments, the processor may divide the training dataset into at least one sub-dataset based on the sample ambient temperature percentage feature and/or the sample charging mode percentage feature.

In some embodiments, the processor may divide the ambient temperature into a plurality of temperature ranges by a high temperature threshold and a low temperature threshold. For example, the ambient temperature above the high temperature threshold is classified as a high ambient temperature, an ambient temperature between the high and low temperature thresholds is classified as a medium ambient temperature, and an ambient temperature below the low temperature threshold is classified as a low ambient temperature. Correspondingly, the sample ambient temperature percentage feature is also categorized as a predominantly high ambient temperature, a predominantly medium ambient temperature, or a predominantly low ambient temperature.

In some embodiments, the processor may calculate the percentage of the ambient temperatures located in various temperature ranges based on the sample ambient temperature percentage, and determine a sample ambient temperature percentage feature based on a temperature range with the highest percentage. For example, if the percentage of high ambient temperatures is the largest, the sample ambient temperature percentage feature is characterized as the predominantly high ambient temperature.

The high temperature threshold and the low temperature threshold may be preset values, for example, the high temperature threshold may be 30° C. and the low temperature threshold may be 15° C. In some embodiments, the processor may also determine different high temperature thresholds and low temperature thresholds based on different seasons at the position of the closed charging place.

Taking a high temperature threshold of 30° C. and a low temperature threshold of 15° C. as an example, assuming that the sample ambient temperature percentage of a set of training data is (([10, 11), 40%), ([20, 21), 25%), ([25, 26), 20%), ([33, 34), 15%)), the percentage of low ambient temperatures is 40%, that of medium ambient temperatures is 45%, and that of high ambient temperatures is 15%. Therefore, the sample ambient temperature percentage of this training data is characterized by a predominance of medium ambient temperature.

According to the relevant content of FIG. 2, it may be seen that charging modes are categorized into fast charging and slow charging, and accordingly, the sample charging mode percentage feature is also categorized into a predominantly fast charging and a predominantly slow charging.

In some embodiments, the processor may determine the sample charging mode percentage feature based on the sample charging mode percentage. If the percentage of the fast charging is greater than the percentage of the slow charging, the sample charging mode percentage feature is characterized as the predominantly fast charging; otherwise, the sample charging mode percentage feature is characterized as the predominantly slow charging.

In some embodiments, the processor may divide the training dataset into at least one sub-dataset based on the sample ambient temperature percentage feature and the sample charging mode percentage feature. For example, the training data with the predominantly high ambient temperature and the fast charging of the sample usage feature constitute a first sub-dataset; the training data with the predominantly high ambient temperature and the slow charging of the sample usage feature constitute a second sub-dataset; the training data with the predominantly medium ambient temperature and the fast charging of the sample usage feature constitute a third sub-dataset; the training data with the predominantly medium ambient temperature and the slow charging of the sample usage feature constitute a fourth sub-dataset; the training data with the predominantly low ambient temperature and the fast charging of the sample usage feature constitute a fifth sub-dataset; the training data with the predominantly low ambient temperature and the slow charging of the sample usage feature constitute a sixth sub-dataset.

In some embodiments, a count of samples determined from each sub-dataset needs to be relatively balanced so that there is sufficient training data available in different charging modes to ensure that the feature determination model is effective in processing in different charging modes.

In some embodiments, the processor may determine the first training sample from different sub-datasets based on a sampling ratio.

The sampling ratio is a ratio of training data drawn from the sub-dataset, and different sub-datasets correspond to different sampling ratios.

In some embodiments, the sampling ratio is correlated with the count of the sample usage features in the sub-datasets. The larger the count of the sample usage features in the sub-datasets is, the smaller the corresponding sampling ratios of the sub-datasets is. The processor may adjust the sampling ratio corresponding to each of the sub-datasets so that the count of training data drawn from each sub-dataset is close to the same.

After determining the sampling ratio, the processor may sample each sub-dataset based on the sampling ratio, obtain the first training sample; based on the first training sample, train the initial feature determination model by the method described above, obtain the feature determination model.

Embodiments of the present disclosure, by adjusting the sampling ratio corresponding to the sub-datasets, the count of training data drawn from each sub-dataset is relatively balanced to ensure the training effect of the feature determination model.

Some embodiments of the present disclosure, wherein the feature determination model is trained by means of sampling training, are able to reduce the count of training while ensuring the accuracy and robustness of the feature determination model.

In some embodiments of the present disclosure, the charging feature of each of the one or more vehicles to be charged is determined by the feature determination model, and results obtained are more accurate, which helps in scheduling the vehicle to be charged, reduces time spent by the user, and improves the user experience.

FIG. 4 is a schematic diagram illustrating a process of determining a stopping instruction according to some embodiments of the present disclosure.

In some embodiments, the processor may determine a charging load extreme value 420 of the closed charging place based on a rated power 410 of the ventilation device in the ventilation module; in response to a sum of the charging power 430 of the at least one currently vehicle to be charged is greater than the charging load extreme value 420, at least one of the following operations is performed: generating the stopping instruction 440 to pause the addition of a new vehicle to be charged; generating a charging instruction 450 to control the charging module to charge the vehicle to be charged in a prioritized order.

The rated power of the ventilation device is an output power of the ventilation device when it is working normally. The rated power of the ventilation device is a preset value.

In some embodiments, the charging power of the vehicle to be charged is a preset value, and the processor may obtain the charging power of the vehicle to be charged via memory.

In some embodiments, different vehicles to be charged correspond to different charging features and charging power, and the processor may determine the charging power of the vehicle to be charged based on the charging feature of the vehicle to be charged. For example, the processor may determine the charging power of the vehicle to be charged based on the charging feature of the vehicle to be charged by querying a third preset table. The third preset table includes a correspondence between the charging feature of the vehicle to be charged and the charging power, which may be determined based on historical data. More description about the charging feature may be found in FIG. 2 and its related description.

The charging load extreme value is a maximum charging power allowed to be charged simultaneously in the closed charging place at the rated power of the ventilation device.

In some embodiments, the processor may determine the charging load extreme value on the closed charging place based on a predicted heat growth rate and a heat dissipation rate of the ventilation device.

The predicted heat growth rate refers to a rate at which the vehicle to be charged is predicted to generate heat during the charging process. In some embodiments, the predicted heat growth rate is positively correlated with the sum of the charging power of the vehicle to be charged and negatively correlated with the charging efficiency. The processor may calculate the predicted heat growth rate based on the sum of the charging power of the vehicle to be charged and the charging efficiency, using the following equation (5):

$${V}_{q} = {P}_{t} ( 1 - η ) \qquad ( 5 )$$

Wherein, V_{q} is the predicted heat growth rate, Pₜ is the sum of the charging powers of the vehicle to be charged, and η is the charging efficiency.

The charging efficiency refers to a proportion of electrical energy obtained from the charging station that is converted into chemical energy stored in the vehicle's battery during the vehicle's charging process. In some embodiments, the processor may determine the charging efficiency based on historical data or prior experience. The heat dissipation rate of the ventilation device indicates the ability of the ventilation device to remove heat from the closed charging place.

In some embodiments, the processor may determine the heat dissipation rate by the ventilation device in the closed charging place based on the rated ventilation power of the ventilating device and aspatial feature of the closed charging place. The spatial feature may include a volume and a ventilation area of the closed charging place.

In some embodiments, the processor may also measure the temperature change within the space before and after the operation of the ventilation device via a thermal sensor and/or other instruments to calculate the heat dissipation rate.

In some embodiments, based on the heat dissipation rate by the ventilation device and the predicted heat growth rate, the processor may determine the sum of the charging power Pt corresponding to the vehicle to be charged when the following equation (6) is satisfied as the charging load extreme value:

$${V}_{r} - {V}_{q} \geq v \qquad ( 6 )$$

Wherein Vᵣ is the heat dissipation rate of the ventilation device, and v is a preset rate difference that may be set based on historical experience.

In some embodiments, the processor may further generate at least one candidate charging map; by means of the temperature prediction model, predict an estimated average temperature corresponding to the candidate charging map at a preset future time; and, in response to the estimated average temperature corresponding to the candidate charging map satisfying a preset condition, determining the charging load extreme value based on the candidate charging map.

The temperature prediction model is a model configured to predict the estimated average temperature corresponding to the candidate charging map. The temperature prediction model may be a graph neural network (GNN) model, etc.

An input to the temperature prediction model is the candidate charging map and an output is the estimated average temperature of each node in the candidate charging map.

The estimated average temperature is an average of the preset temperatures at a preset time in the future corresponding to the candidate charging map. The foregoing preset time may be determined based on an average charging duration of the charging vehicle. In some embodiments, the preset time may also be determined based on a priori experience or actual needs.

The candidate charging map consists of multiple nodes and multiple edges connecting the nodes, where each node has corresponding node features and each edge has corresponding edge features.

In some embodiments, the processor may randomly generate a plurality of the candidate charging maps based on the rated power of the ventilation device, the charging power of the vehicle to be charged, and the plurality of the candidate charging maps have the same structure, i.e., a plurality of nodes, the edges of the candidate charging maps, the edge features, the rated power of the ventilation device and the charging power in the node features are the same, and the enablement tags in the node features may be different.

The nodes of the candidate charging map correspond to the charging station of the electric vehicle that are connected. The node features may reflect the relevant features of the charging station. For example, the node features include the rated power of the ventilation device, the charging power, and the enablement tags. More description about how to determine the charging power may be found above.

The rated power of the ventilation device at different nodes may be the same or different. When the ventilation device is a centralized ventilation device, the rated power of the ventilation device at different nodes are the same. When the ventilation device is distributed ventilation device, the rated power of the ventilation device at different nodes are different.

The enablement tag is a Boolean value that indicate whether the nod is to be charged. The enablement tag of 1 indicates that the node is charging, and the enablement tag of 0 indicates that the node is not charging.

The ventilation device at different nodes may have different rated power, charging power, and different abilities to generate and expel heat while charging. With the introduction of enablement tags, multiple combinations of charging/non-charging of individual nodes may be realized, resulting in multiple candidate charging maps. Determining the charging load extreme value based on multiple candidate charging maps gives more accurate results.

In some embodiments, there exists an edge between any two nodes of the candidate charging map. The edge feature is characterized as a distance between the two nodes.

Since any two nodes are connected to each other by edges, the count of edges increases dramatically as the count of nodes increases, e.g., there will be more than 5000 edges in the candidate charging map when the count of nodes is 100. At this time, the count of data to be processed by the temperature prediction model is too large and the efficiency is low, so a part of the edges in the candidate charging map need to be removed to improve the processing efficiency of the temperature prediction model.

In some embodiments, when the count of edges in the candidate charging map exceeds the preset threshold, the processor may remove the edges by the following steps:

In 1, all edges may be sorted in descending order based on the distance between two nodes in the edge features to obtain a sorting result;

In 2, for a first edge in the sorting result, if the removal of the edge does not affect the connectivity of the candidate charging map, remove the edge and eliminate the edge from the sorting result; otherwise, only remove the edge from the sorting result. The connectivity of the candidate charging map means that each node in the candidate charging map is connected to the other nodes by at least one edge;

In 3, the operation 2 may be repeated until the count of the edges is less than a preset threshold.

In some embodiments, the temperature prediction model may be obtained by training a plurality of second training samples with second labels. For example, the plurality of the second training samples with the second labels may be input into the initial temperature prediction model, a loss function is constructed from the second labels and the output of the initial temperature prediction model, and the loss function is iteratively updated based on the loss function by gradient descent or other methods to iteratively update parameters of the initial temperature prediction model. The model training is completed when a preset condition is met, and the trained temperature prediction model is obtained. The preset condition may be that the loss function converges, a count of iterations reaches a threshold, or the like.

In some embodiments, the second training samples include a sample candidate charging map, and the second labels are sample average temperatures corresponding to the second training samples. In some embodiments, the processor may construct the second training samples based on the historical distribution of the electric vehicle at different historical times in the closed charging place, historical charging power, and the rated power of the ventilation device in the historical data, the second labels include the sample average temperatures corresponding to the sample candidate charging map. In some embodiments, the processor may use the average of the ambient temperature at the preset time after the actual charging as the sample average temperatures.

The nodes in the sample candidate charging map are the charging stations with connected the electric vehicles in the historical data, and the node features include the rated power of the ventilation device, historical charging power, and historical enablement tags characterizing the historical enablement of the charging stations; the sample candidate charging map exist the edges between any two nodes, and the edge features represent the distances between the nodes.

In some embodiments, the processor may identify candidate charging maps whose estimated average temperatures lie within a preset temperature range (e.g., 10° C.-35° C.) as target charging maps; calculate the total charging power for each target charging map, e.g., the processor may sum the charging powers of nodes in the target charging maps with the enablement tags of 1 to obtain the total charging power for the target charging map; based on the total charging power, sort the target charging maps in descending order, and average the total charging power of the top N % of the target charging profiles, determining the average value as the charging load extreme value. N is a preset value, which may be determined according to actual needs.

The charging load extreme value is too high, allowing too many vehicles to charge at the same time, which may lead to system overload and cause various safety accidents; the charging load extreme value is too low, allowing too few vehicles to charge at the same time, which does not make full use of the electric power resources, and the vehicle charging needs to wait for a longer time, greatly affecting the user experience. In some embodiments of the present disclosure, the charging load extreme value is determined by the temperature prediction model, and the obtained charging load extreme value is more reasonable, and may fully utilize the electric power resources under less risky conditions.

The stopping instruction is an instruction for pausing the addition of the new vehicle to be charged. In some embodiments, the processor generates the stopping instruction when the total charging power is greater than the charging load extreme value to avoid risks associated with power overload in the closed charging place.

When the total charging power is less than the charging load extreme value, the processor may generate the charging instruction to control the charging module to charge the vehicle to be charged in the prioritized order.

The prioritized order refers to the order in which the vehicle to be charged is charged. When the total charging power is less than the charging load extreme value, the vehicle to be charged with a higher priority is charged first.

In some embodiments, the processor may determine the prioritized order based on at least one of a change in the charging cycle variation, the battery capacity variation, and the admission time of the vehicle to be charged. The shorter of the charging cycle is, the greater of the battery capacity variation is, and the earlier of the admission time of the vehicle to be charged is, the higher the priority of the vehicle to be charged is.

Some embodiments of the present disclosure are able to shorten the average waiting time of a user and improve the user experience by charging the vehicle to be charged in the prioritized order.

Embodiments of the present disclosure may fully utilize the power resources of the closed charging place by determining the charging load extreme value; may avoid accidents caused by the total charging power exceeding the charging load extreme value by generating the stopping instruction; and may strengthen the management of the vehicle to be charged by the prioritized order the charging of the vehicle to be charged, the operational efficiency of the closed charging place may be improved, and the user experience may be enhanced.

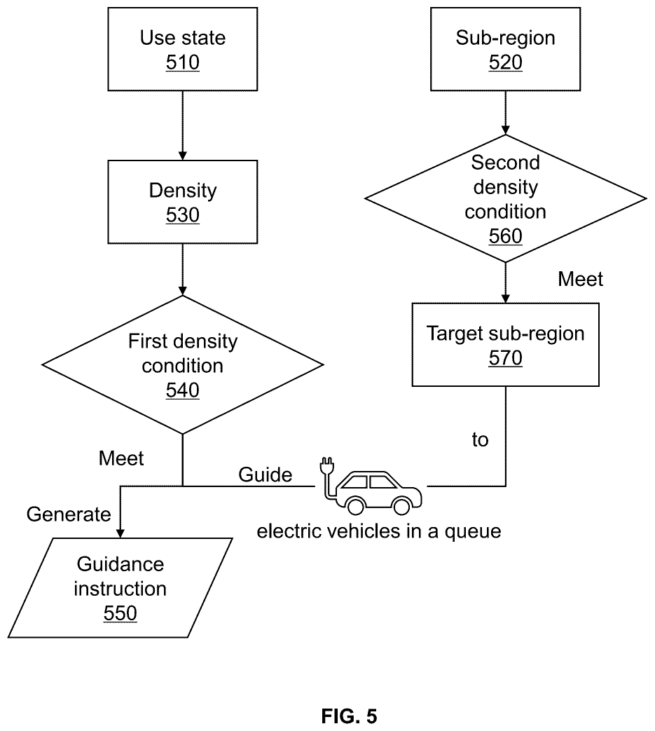

FIG. 5 is a schematic diagram illustrating a process of performing a guidance operation according to some embodiments of the present disclosure.

In some embodiments, based on a use state of the charging module 510, the processor may also determine a density 530 of the charging stations in operation in at least one sub-region 520 of the closed charging place; in response to the sub-region 520, if the density 530 of the charging stations in operation does not satisfy a first density condition 540, at least one of the following operations is carried out: generating a guidance instruction 550 to guide each of the one or more vehicles to be charged to a specified charging position; guiding the electric vehicles in a queue to a target sub-region 570, where the target sub-region being a region where the density satisfies a second density condition 560; wherein the first density condition includes a density less than a first density threshold; the second density condition includes a density being less than a second density threshold.

The use state of the charging module refers to whether or not the charging station corresponding to the charging module is in charging operation.

In some embodiments, the use state of the charging module may be obtained by a current sensor. More description about the current sensor may be found in FIG. 1 and its related description.

The sub-region is a subdivision obtained by dividing the closed charging place. In some embodiments, the processor may divide the closed charging place into a plurality of the sub-regions with the same total count of the charging stations. The sub-regions may be divided in a variety of ways. For example, the sub-regions may be divided based on a grid of geographic positions or the distribution of the charging stations, among other ways.

The density is a measure of the compactness of the charging stations in operation in different sub-regions of the closed charging place. For example, a higher degree of the density indicates that more electric vehicles are charging with the charging stations in the sub-regions, while a lower degree of the density indicates that the sub-regions are relatively empty and fewer electric vehicles are charging with charging stations.

In some embodiments, the processor may determine the density of the charging stations in operation in each sub-region of the closed charging place based on the use state of the charging module. For example, the processor counts the count of the charging stations in operation in each sub-region and, based on the count of the charging stations in operation as a percentage of the total count of the charging stations in the sub-region, determines the density of the charging stations in operation in the sub-region.

The density condition is a judgment condition configured to determine the density of the charging stations in operation in the sub-region. In some embodiments, the density condition may include the first density condition, the second density condition, or the like.

The first density condition consists of a density less than the first density threshold.

The first density threshold is a threshold configured to determine whether the sub-region is prone to congestion for vehicle entry.

In some embodiments, the first density threshold may be determined based on the ambient temperature.

In some embodiments, the first density threshold is negatively correlated with the ambient temperature. For example, a higher ambient temperature may lead to safety hazards, such as fire. Therefore, severe congestion at this time will have a greater impact, hence the higher the temperature is, the lower the first density threshold is.

The second density condition consists of the density less than the second density threshold.

The second density threshold is a threshold configured to determine whether the charging stations are relatively idle in the sub-regions.

In some embodiments, the second density threshold may be determined based on the historical failure rate of the charging station.

In some embodiments, the second density threshold is negatively correlated with historical failure rates of the charging stations. If the failure rate of charging stations is high, it may lead to a decrease in the effective utilization rate of the charging stations. Therefore, a lower preset threshold may be set for timely scheduling operations to respond to possible failure situations.

The guidance instruction is an instruction configured to direct users to the specified charging position.

In some embodiments, the processor may determine the guidance instruction based on the density of different sub-regions. For example, the closed charging place is divided into sub-regions A, B, C, D, etc. If regions A and B have densities higher than the first density threshold, while at the same time regions C and D have lower than the second density threshold, the guidance instruction may indicate that users may choose to go to regions C or D for charging.

The target sub-regions are the sub-regions within the closed charging place where the charging stations are more vacant. In some embodiments, the target sub-regions may be determined based on the density. In some embodiments, a region whose density satisfies the second density condition may be determined as the target sub-region.

In some embodiments, the total charging power of the vehicle to be charged is less than the charging load extreme value, and the processor may direct subsequent queued vehicle to be charged awaiting charging to charge in a less density region. More description about the charging load extreme value may be found in FIG. 4 and its related description.

In some embodiments, the processor is further configured to perform a guidance operation to generate the guidance instruction based on the densities of the charging stations, adjust the density thresholds based on the ambient temperatures and the historical failure rates of the charging stations, and guide the vehicle to be charged to a specified charged position based on the density thresholds to avoid dangerous situations caused by congestion.

The basic concepts have been described above, apparently, in detail, as will be described above, and does not constitute limitations of the disclosure. Although there is no clear explanation here, those skilled in the art may make various modifications, improvements, and modifications of present disclosure. This type of modification, improvement, and corrections are recommended in present disclosure, so the modification, improvement, and the amendment remain in the spirit and scope of the exemplary embodiment of the present disclosure.

At the same time, present disclosure uses specific words to describe the embodiments of the present disclosure. As “one embodiment”, “an embodiment”, and/or “some embodiments” means a certain feature, structure, or characteristic of at least one embodiment of the present disclosure. Therefore, it is emphasized and should be appreciated that two or more references to “an embodiment” or “one embodiment” or “an alternative embodiment” in various parts of present disclosure are not necessarily all referring to the same embodiment. Further, certain features, structures, or features of one or more embodiments of the present disclosure may be combined.

In addition, unless clearly stated in the claims, the order of processing elements and sequences, the use of numbers and letters, or the use of other names in the present disclosure are not used to limit the order of the procedures and methods of the present disclosure. Although the above disclosure discusses through various examples what is currently considered to be multiple useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

At last, it should be understood that the embodiments described in the present disclosure are merely illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A charging scheduling system based on a usage feature of an electric vehicle, wherein the system is applied to a closed charging place, comprises: a transmission module, a charging module, a monitoring module, a ventilation module, and a processor;
the transmission module is communicatively connected to one or more vehicles to be charged and configured to obtain historical usage features from an internal storage unit of the vehicle to be charged, the one or more vehicles to be charged binding a charging station;
the charging module is configured to supply power to the one or more vehicles to be charged, the charging module at least including a winding, a current conversion unit, and a pulse transformer;
the monitoring module is configured to obtain an ambient temperature of the closed charging place, the ambient temperature including a temperature of at least one point in the closed charging place;
the ventilation module is configured to implement a ventilation function to dissipate heat from the closed charging place; and
the processor is communicatively connected to the transmission module, the charging module, the monitoring module, and the ventilation module, respectively, and the processor is configured to:
obtain a charging feature of each of the one or more vehicles to be charged based on the historical usage features;
generate a scheduling instruction based on the ambient temperature and the charging feature, and send the scheduling instruction to the charging module; the scheduling instruction is configured to adjust a series-parallel state of the pulse transformer in the charging module, to adjust a charging power of the charging module; and
in response to the ambient temperature satisfying a preset temperature condition, generate a heat dissipation instruction and send the heat dissipation instruction to the ventilation module.

2. The system of claim 1, wherein for each of the one or more of the vehicles to be charged, the historical usage features include sub-historical usage features of the vehicle to be charged collected at a preset historical time;
the processor is further configured to:
determine a feature sampling parameter of the vehicle to be charged based on the sub-historical usage features;
determine a target sub-usage feature set of the vehicle to be charged based on the sub-historical usage features and the feature sampling parameter; and
obtain the charging feature of the vehicle to be charged by a feature determination model based on the target sub-usage feature set, the feature determination model being a machine learning model.

3. The system of claim 2, wherein the sub-historical usage features include at least one of a historical ambient temperature percentage and a historical charging mode percentage collected at the preset historical time.

4. The system of claim 2, wherein the processor is further configured to:
train an initial feature determination model based on a first training sample to obtain the feature determination model;
wherein the first training sample includes a sample sub-usage feature set of historical vehicles to be charged, and a first label used for training includes historical charging features of the historical vehicles to be charged.

5. The system of claim 4, wherein the processor is further configured to:
obtain a training dataset based on historical charging data, wherein the training dataset includes at least one sample usage feature, and the sample usage feature includes a sample ambient temperature percentage and a sample charging mode percentage;
divide the training dataset into at least one sub-dataset; and
determine a sampling ratio corresponding to each sub-dataset, and sample each sub-dataset based on the sampling ratio to obtain the training sample.

6. The system of claim 5, wherein the processor is further configured to:
divide the training dataset into multiple sub-datasets based on at least one of the sample ambient temperature percentage feature and the sample charging mode percentage feature.

7. The system of claim 5, wherein the sampling ratio is correlated with a count of sample usage features in the sub-dataset.

8. The system of claim 1, wherein the processor is further configured to:
determine a charging load extreme value of the closed charging place based on a rated power of a ventilation device in the ventilation module; and
in response to a sum of charging power of the one or more vehicles to be charged being greater than the charging load extreme value, perform at least one of the following operations, including:
generating a stopping instruction to stop adding a new vehicle to be charged; and
generating a charging instruction to control the charging module to charge the one or more vehicles to be charged in a prioritized order.

9. The system of claim 8, wherein the processor is further configured to:
determine the prioritized order based on at least one of a charging cycle variation, a battery capacity variation, and an admission time of each of the one or more vehicles to be charged.

10. The system of claim 8, wherein the processor is further configured to:
generate a candidate charging map;
predict an estimated average temperature corresponding to the candidate charging map in a preset future time, by a temperature prediction model, the temperature prediction model being a machine learning model; and
in response to the estimated average temperature corresponding to the candidate charging map satisfying a preset condition, determine the charging load extreme value based on the candidate charging map.

11. The system of claim 10, wherein the processor is further configured to:
train an initial temperature prediction model based on a second training sample to obtain the temperature prediction model;
wherein the second training sample includes at least one sample candidate charging map, and a second label used for training including a sample average temperature corresponding to the sample candidate charging map.

12. The system of claim 10, wherein the candidate charging map includes a plurality of nodes and a plurality of edges connecting the nodes; wherein
each of the nodes represents a charging station connected with an electric vehicle, and a node feature corresponding to each of the nodes includes a rated power of a ventilation device corresponding to the charging station, a charging power of the charging station, and an enablement tag represents an operating state of the charging station; and
each of the edges is arranged between any two of the nodes, and an edge feature correspond to each of the edges includes a distance between two nodes connected by each of the edges.

13. The system of claim 8, wherein the charging module further includes a current sensor, the current sensor is configured to obtain a use state of the charging module;
the processor is further configured to perform a guidance operation, including:
determining a density of charging stations in operation in at least one sub-region of the closed charging place based on the use state of the charging module;
in response to the density of the charging stations in operation in the sub-region not satisfying a first density condition, performing at least one of following operations, including:
generating a guidance instruction to guide the one or more vehicles to be charged to a specified charging position; and
guiding an electric vehicle in a queue to a target sub-region, the target sub-region being a region where the density satisfies a second density condition;
wherein
the first density condition includes the density being less than a first density threshold;
the second density condition includes the density being less than a second density threshold.

14. The system of claim 13, wherein the first density threshold is negatively correlated with the ambient temperature.

15. The system of claim 13, wherein the second density threshold is negatively correlated with a historical failure rate of the charging station.
